(19) United States
(12) Patent Application Publication
(10) Pub. No.: US 2004/0204272 A1
(43) Pub. Date: Oct. 14, 2004

(54) Hydraulic tensioner

(75) Inventors: Shin Seungpyo, Nabari (JP); Shinichiro Nakada, Nabari (JP)

Correspondence Address: BORGWARNER INC., POWERTRAIN TECHNICAL CENTER, 3800 AUTOMATION AVENUE, SUITE 100, AUBURN HILLS, MI, 48326-1782, US

(73) Assignee: BorgWarner Morse TEC Japan K.K., Nabari (JP)

(21) Appl. No.: 10/796,347

(22) Filed: Mar. 9, 2004

(30) Foreign Application Priority Data
Mar. 20, 2003 (JP) 2003-78849
Mar. 31, 2003 (JP) 2003-95928

(51) Int. Cl. B67D 5/22

(52) U.S. Cl. 474/109

(57) ABSTRACT

A hydraulic tensioner includes a housing with a piston bore. A hollow piston with rack teeth on an outer circumference is inserted slidably in the piston bore, forming a fluid chamber. A piston spring urges the piston to extend. A retraction blocking member such as a pawl is provided in a retraction blocking member opening. The pawl has teeth engageable with the piston rack teeth, and a pawl spring that urges the teeth of the pawl member to engage the rack teeth. The width of the pawl member is greater than the width of the tip portion of the rack teeth of the piston. In one embodiment, a pawl retainer is mounted at a retainer hole and houses the pawl. In this embodiment, the width of the axial portion of the pawl retainer is greater than the width of the tip portion of the rack teeth of the piston.

### REFERENCE TO RELATED APPLICATIONS

This application claims an invention which was disclosed in Japanese Application Number 2003-78849, filed Mar. 20, 2003, entitled “Hydraulic Tensioner,” and Japanese Application Number 2003-95928, filed Mar. 31, 2003, entitled “Hydraulic Tensioner.” The benefit under 35 USC §119(a) of these applications is hereby claimed, and the aforementioned applications are hereby incorporated herein by reference.

### BACKGROUND OF THE INVENTION

1. Field of the Invention

The invention pertains to the field of hydraulic tensioners for imparting appropriate tension to a chain, belt or the like. More particularly, it pertains to hydraulic tensioners having a ratchet mechanism to prevent retraction of a piston at the time of decreased hydraulic pressure.

2. Description of Related Art

A hydraulic tensioner generally includes a housing, a hollow piston that is fitted slidably into a bore formed in the housing and that is biased in a protruding direction by a spring, and a fluid chamber defined by the piston and its hole inside the bore of the housing. During operation, force from a chain or belt imparted to a distal end of the piston is, ideally, balanced by combined efforts of the spring load and hydraulic pressure in the chamber. However, when used with an automobile timing system, force imparted from a chain to the distal end of the piston (while there is inadequate hydraulic pressure in the chamber—such as at the time of engine start), easily forces the piston to retract into the housing, thereby causing noise or oscillation.

In order to prevent such retraction of a piston, a hydraulic tensioner with a ratchet mechanism has been proposed, such as shown in Japanese patent application laid-open publication No. 2002-147551.

This ratchet mechanism includes rack teeth formed around an outer circumference of the piston, a toothed pad that has teeth engageable with the rack teeth of the piston provided in a laterally extending pawl hole of the housing, and an annular spring biasing the toothed pad against the rack teeth. Also, a longitudinal length of the toothed pad is slightly shorter than the axial length of the through hole or pawl hole of the housing. The toothed pad can thus be moved in the axial direction inside the pawl hole of the housing according to the axial movement of the piston.

In the prior art ratchet mechanism, a pawl member such as a toothed pad engageable with the rack teeth of the piston serves as a retraction blocking member and has a width corresponding to the width of the rack teeth. The width of the pawl member is smaller than that of a tip portion of the rack teeth.

Therefore, when excessive tension occurs in the chain and an excessive load is applied to the tip end of the piston from the chain, the pawl member travels in the pawl hole of the housing in the axial backward direction along with the piston and presses against the inside wall surface of the pawl hole. As a result, the inside wall surface of the pawl hole may be deformed, and in an extreme case, the pawl member may be locked between the rack teeth of the piston and the inside wall surface of the pawl hole of the housing.

The present invention addresses such a problem and its object is to provide a hydraulic tensioner with a retraction blocking member that can prevent excessive pressure from being applied to the housing at the time of retraction of the piston.

### SUMMARY OF THE INVENTION

The hydraulic tensioner of the present invention includes a housing that has a piston hole with one end opening outside the housing, a radial retraction blocking member opening into the piston hole inside the housing, and a hollow piston axially slidable in the piston hole having an inside space that forms a fluid chamber with the piston hole. The piston is formed with rack teeth on at least a portion of its outer circumference. A piston spring provided in the piston hole biases the piston in the protruding, or extending, direction. A retraction blocking member is provided in the retraction blocking member opening of the housing having a teeth portion engageable with the rack teeth of the piston and adapted to permit the movement of the piston in the extending direction but to prevent its movement in the retracting direction. A retraction blocking member spring biases the teeth portion in the engaging direction with the rack teeth. The retraction blocking member has a width greater than that of a tip portion of the rack teeth of the piston.

In a first preferred embodiment, the retraction blocking member opening is a pawl hole opening into the piston hole inside the housing and the retraction blocking member is a pawl member provided in the pawl hole of the housing with an axial clearance formed between the pawl hole and the pawl member. In this embodiment, the pawl member has the teeth portion engageable with the rack teeth of the piston. Likewise, the retraction blocking member spring biasing the teeth portion in the engaging direction with the rack teeth is a pawl spring provided in the pawl hole of the housing that biases the pawl member in the engaging direction of the teeth portion with the rack teeth. The pawl member has a width greater than that of a tip portion of the rack teeth of the piston.

When the piston moves a greater distance in the protruding direction, the rack teeth of the piston pass several teeth of the teeth portion of the pawl member. When the combined efforts of the force of the piston spring and the hydraulic pressure in the fluid chamber balance the compressive force of the chain imparted to the distal end of the piston, the piston stops.

Next, when the compressive force from the chain is applied to the distal end of the piston in the case of inadequate hydraulic pressure inside the fluid chamber, the piston retracts along with the pawl member with the engagement of the rack teeth of the piston with the teeth portion of the pawl member maintained and the rear end surface of the pawl member presses against the inside wall surface of the pawl hole of the housing, thereby causing the travel of the piston to stop.

Since the width of the pawl member is greater than that of the tip portion of the rack teeth of the piston, the contact area is large between the rear end surface of the pawl member and the inside wall surface of the pawl hole of the housing. That is, a pressure surface area on the inside wall surface of the pawl hole of the housing is large, thereby preventing excessive pressure from being applied to the housing via the pawl member at the time of retraction of the piston.

In another embodiment, the pawl hole has a surface that a front end surface or a rear end surface of the pawl member contacts at the time of forwarding or retracting movement of the pawl member.

In another embodiment, the pawl member has a width greater than that of a bottom portion of the rack teeth of the piston. In this case, the pressure surface of the inside wall surface of the pawl hole of the housing is further enlarged, thereby effectively preventing the excessive pressure from being imparted to the housing through the pawl member at the time of retraction of the piston.

In yet another embodiment, the pawl member has a width greater than that of an outer diameter of the piston. In this case, the pressure surface of the inside wall surface of the pawl hole of the housing is still further enlarged, thereby even more effectively preventing the excessive pressure from being imparted to the housing through the pawl member at the time of retraction of the piston.

In another embodiment, the housing is constructed from a material such as aluminum with a hardness lower than a hardness of the pawl member. In this case, the pawl hole of the housing deforms relatively easily when a high pressure from the pawl member is applied. However, as above-mentioned, since the width of the pawl member is greater than that of at least the tip portion of the rack teeth of the piston, the surface pressure applied to the pawl hole of the housing from the pawl member is decreased. Therefore, even in the event that the housing has a lower hardness, the deformation of the housing can be effectively restrained.

In another embodiment, the pawl spring has at least one U-shaped bent portion that is preferably formed by bending a band-shaped sheet metal. The bent portion contacts a back surface of the pawl member.

In another embodiment, the pawl spring has two U-shaped bent portions each of which is symmetrically disposed about an axial centerline of the piston to make a W-shape. In this case, the engagement of the teeth portion of the pawl member with the rack teeth of the piston can be stably maintained without inclining the pawl member.

In another embodiment, the pawl spring has at least one U-shaped bent portion that is preferably formed bending a band-shaped sheet metal, and the pawl member has an axially extending groove on a back surface. The U-shaped bent portion of the pawl spring engages the groove.

In this case, when the pawl member travels together with the piston, the pawl member is guided by the U-shaped bent portion of the pawl spring, thereby allowing for a stable axial movement of the pawl member. Moreover, in this case, since a groove is formed on the backside of the pawl member, the center of the moment of inertia of the pawl member is moved toward the teeth portion of the pawl member. Thereby, when revolutionary moment from the piston is applied to the pawl member, lift-off of the pawl member is restrained or prevented.

In yet another embodiment, the pawl spring has a pair of engaging hooks at opposite ends thereof and the housing may have a pair of engagement recesses at opening ends of the pawl hole. The engaging hooks of the pawl spring are engageable with the engagement recesses of the housing.

In another embodiment, the housing has a check valve at a bottom portion of the piston hole. The check valve is adapted to permit fluid flow into the chamber but to block reverse flow out of the chamber.

In a second preferred embodiment, the retraction blocking member opening is a retainer hole radially penetrating to the piston hole inside the housing. Further, the retraction blocking member includes a pawl retainer mounted on the retainer hole, where the pawl retainer has a pawl housing hole for housing a pawl member. The pawl member is disposed on the rack teeth of the piston in the retainer hole. The pawl member has a teeth portion engageable with the rack teeth of the piston. The spring biasing the teeth portion in the engaging direction with the rack teeth is, as in the first preferred embodiment, a pawl spring. However, in this embodiment, it is the attachment surface of the pawl retainer relative to the retainer hole that has a width greater than that of a tip portion of the rack teeth of the piston.

When the compressive force from the chain is applied to the distal end of the piston in the case of inadequate hydraulic pressure inside the fluid chamber, the piston retracts along with the pawl member with the engagement of the rack teeth of the piston with the teeth portion of the pawl member maintained. The rear end surface of the pawl member presses against the pawl housing hole of the pawl retainer, thereby causing the travel of the piston to stop.

At this time, the pawl member exerts pressure on the inside wall surface of the retainer hole of the housing via the pawl retainer. Since the width of the attachment surface of the pawl retainer relative to the retainer hole is made greater than that of the tip portion of the rack teeth of the piston, the pressure surface area on the inside wall surface of the retainer hole of the housing is large, thereby preventing excessive pressure from being applied to the housing via the pawl member at the time of retraction of the piston.

In one embodiment, the attachment surface of the pawl retainer relative to the retainer hole has a width greater than that of a bottom portion of the rack teeth of the piston. In this case, the pressure surface area of the inside wall surface of the retainer hole of the housing is further enlarged, thereby effectively preventing the excessive pressure from being imparted to the housing through the pawl member at the time of retraction of the piston.

In another embodiment, the pawl spring has a pair of engaging hooks at opposite ends thereof and the housing may have a pair of engagement recesses at opening ends of the pawl hole. The engaging hooks of the pawl spring are engageable with the engagement recesses of the housing.

In another embodiment, the housing has a counterbore at an opening end of the piston hole, which is greater than the piston hole. The pawl retainer has a lower elongated end disposed in the vicinity of the rack teeth of the piston. The lower elongated end of the pawl retainer is adapted to prevent the piston from rotating.

### BRIEF DESCRIPTION OF THE DRAWINGS

FIG. 1 is a perspective view of a hydraulic tensioner according to a preferred embodiment of the present invention.

FIG. 2 is a longitudinal sectional view of the hydraulic tensioner of FIG. 1.

FIG. 3 is a side view of the hydraulic tensioner of FIG. 2, viewed from an arrow marked direction III.

FIG. 4 is a top plan view illustrating rack teeth of the piston in an embodiment of the present invention.

FIG. 5 is a sectional schematic view taken along line V-V of FIG. 2.

FIG. 6 is an enlarged perspective view of a retraction blocking member opening (or “pawl hole”) of a housing in an embodiment of the present invention.

FIG. 7 is a schematic illustrating a pressure surface caused by a pawl member of the present invention on the housing together with a pressure surface.

FIG. 8 is a lateral sectional view of a variation of the embodiment of the hydraulic tensioner shown in FIG. 5.

FIG. 9 is a perspective view of a hydraulic tensioner according to another preferred embodiment of the present invention.

FIG. 10 is a longitudinal sectional view of the hydraulic tensioner of FIG. 9.

FIG. 11 is a top plan view illustrating rack teeth of the piston in an embodiment of the present invention.

FIG. 12 is an enlarged perspective view of a retraction blocking member opening (or “retainer hole”) of a housing in an embodiment of the present invention.

FIG. 13 is an enlarged perspective view of a pawl retainer of the hydraulic tensioner of FIG. 9.

FIG. 14 is a cross sectional view taken along line VI-VI of FIG. 10.

FIG. 15 is a top plan view of a pawl retainer in an embodiment of the present invention, illustrating the maximum width of the axial portion of the pawl retainer together with the width of the rack teeth of the piston.

FIG. 16 is longitudinal sectional view taken along line VIII-VIII of FIG. 15.

FIG. 17 is a side view of FIG. 10 viewed from the arrow marked direction IX.

FIG. 18 is a perspective view of a pawl retainer according to an embodiment of the present invention.

FIG. 19 is a perspective view of a pawl retainer according to an embodiment of the present invention.

### DETAILED DESCRIPTION OF THE PREFERRED EMBODIMENTS

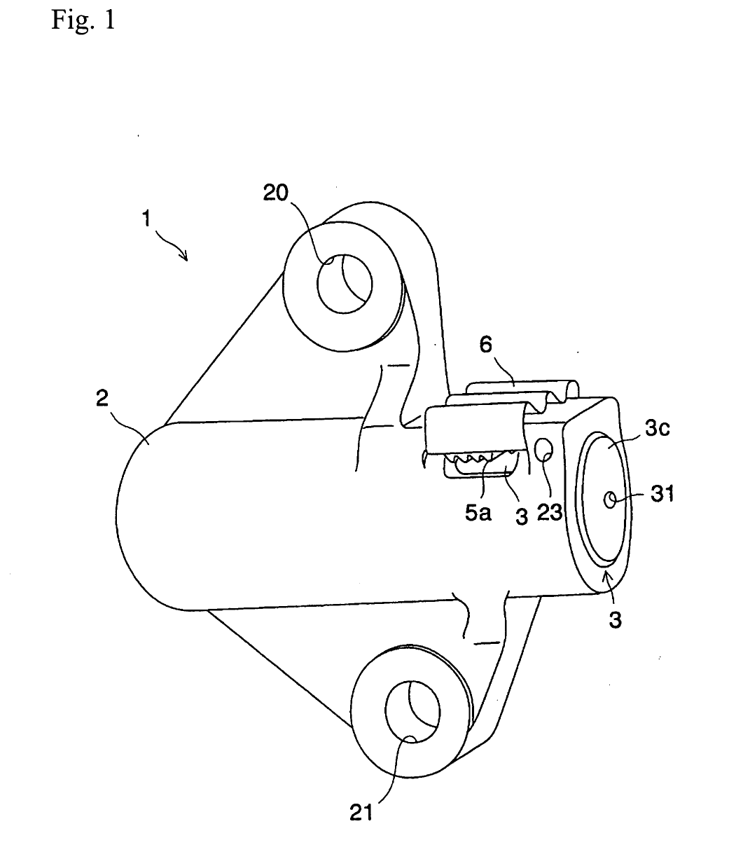

In a preferred embodiment of the present invention, as shown in FIGS. 1-3, a hydraulic tensioner 1 includes a housing 2 with an axially extending piston bore 2a, one end of which opens to the outside of housing. A hollow fitted piston 3 is axially slidable in bore 2a, and a piston spring 4 biases hollow piston 3 in a protruding, or extending, direction from bore 2a.

The housing 2 has attachment holes 20, 21 for inserting bolts (not shown) to fit the tensioner 1 into the engine. Inside the housing 2, a fluid chamber 30 is defined by an inner space 3a formed in the piston 3 and an inside wall surface of the bore 2a. An inlet passage 10 is formed in the housing 2, to introduce engine oil from an outside source of pressurized fluid (not shown) to the fluid chamber 30.

A check valve 7 is preferably provided at a bottom portion of the bore 2a in the housing 2 to permit a flow of fluid into chamber 30 from the inlet passage 10 but to block fluid flow in a reverse direction. Here, a ball-type check valve is used, but any other suitable structure can be employed to form a check valve.

A vent disk 8 is preferably provided on the top side of the inner space 3a of the piston 3 to discharge air trapped in the fluid chamber 30 to the outside of the tensioner and to control leakage of the fluid from the fluid chamber 30. The vent disk 8 has a spiral groove (not shown) on the side surface thereof. The top portion of the piston 3 has an axially extending through hole 31. Air that has been trapped in the fluid chamber 30 along with fluid containing the air is discharged to the outside of the tensioner from the spiral groove of the vent disk 8 via through hole 31. Also, the vent disk 8 has a shaft portion 8a. The piston spring 4 is provided around the shaft portion 8a of the vent disk 8 and an end of the piston spring 4 biases the vent disk 8 toward the top portion of the piston 3.

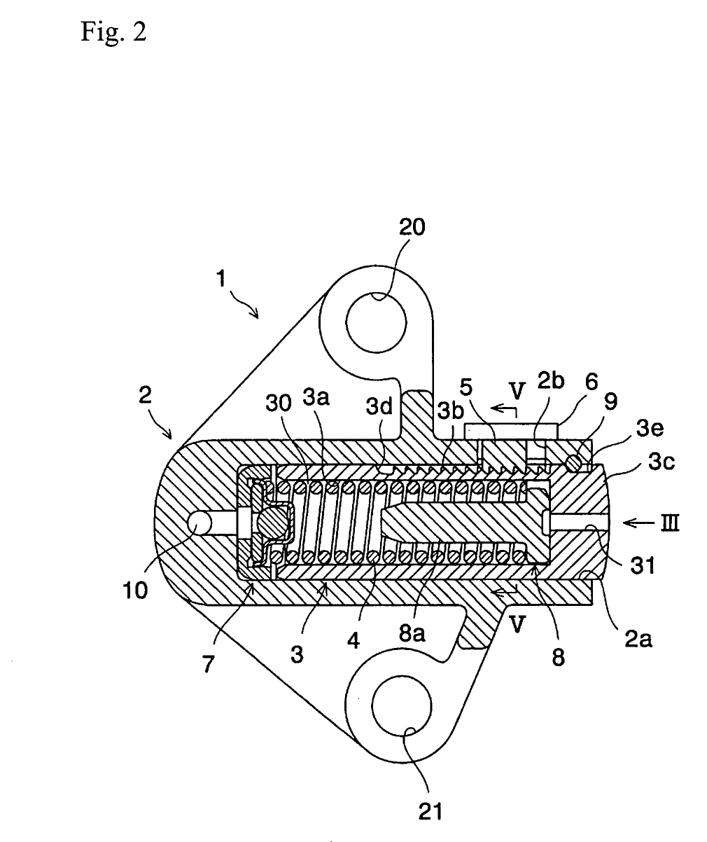

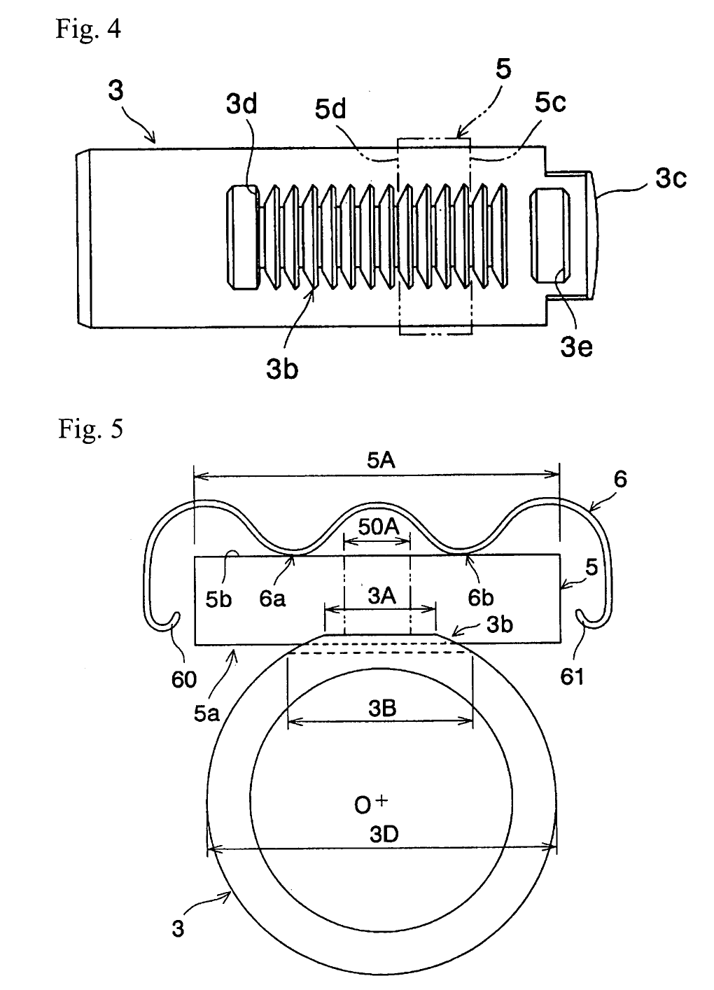

Rack teeth 3b are formed on a portion of an outer circumference of the piston 3 (see FIG. 4). A retraction blocking member opening 2b (or “pawl hole”) opening into the piston bore 2a is formed in the housing 2. A pawl member 5 is disposed in the retraction blocking member opening (hereinafter also referenced for the sake of brevity as “opening 2b”). The pawl member 5 has a teeth portion 5a engageable with the rack teeth 3b of the piston 3 on the bottom surface thereof. An axial clearance is formed between the opening 2b and the pawl member 5 (see FIG. 2).

As shown in FIG. 5, the width 5A of the pawl member 5 is greater than the width 3A of at least the tip portion of the rack teeth 3b of the piston 3. Preferably, the width 5A of the pawl member 5 is greater than the width 3B of the bottom portion of the rack teeth 3b of the piston 3. In a preferred embodiment, the width 5A of pawl member 5 is greater than the outer diameter 3D of the piston 3. (See FIGS. 4 and 5). In FIG. 5, reference numeral 50A indicates a width of a prior art pawl member.

As shown in FIGS. 1-3 and 5, a retraction blocking member spring (“pawl spring 6”), is provided at opening 2b of the housing 2 that biases the pawl member 5 against the rack teeth 3b of the piston 3 to engage the teeth portion 5a of the pawl member 5 with the rack teeth 3b of the piston 3.

The pawl spring 6 preferably has at least one U-shaped portion that has been formed by bending a band-shaped sheet of metal. Here, as shown in FIG. 5, the pawl spring 6 has two U-shaped portions 6a, 6b. In this embodiment, the pawl spring 6 is generally W-shaped. Each of the U-shaped portions 6a, 6b contacts a back surface 5b of the pawl member 5. Preferably, each of the U-shaped portions 6a, 6b is disposed symmetrically about a centerline of the piston 3.

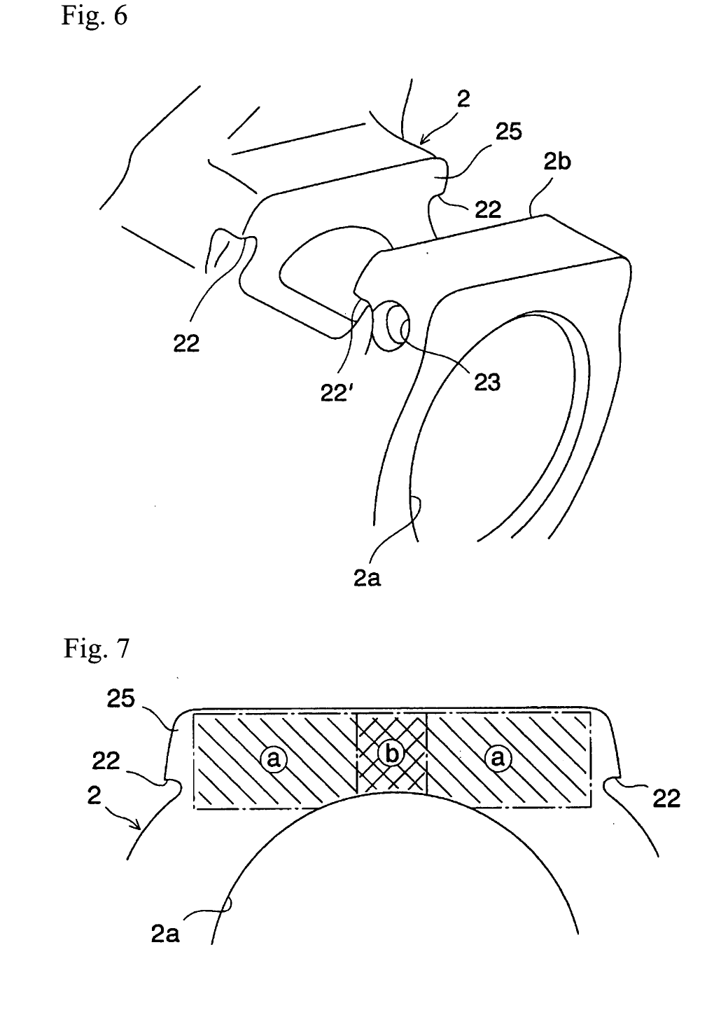

The pawl spring 6 preferably has a pair of engaging hooks 60, 61 at its opposite ends. The housing 2 has, shown in FIG. 6, engaging recesses 22, 22′ adjacent opening 2b for receiving the engaging hooks 60, 61 of pawl spring 6.

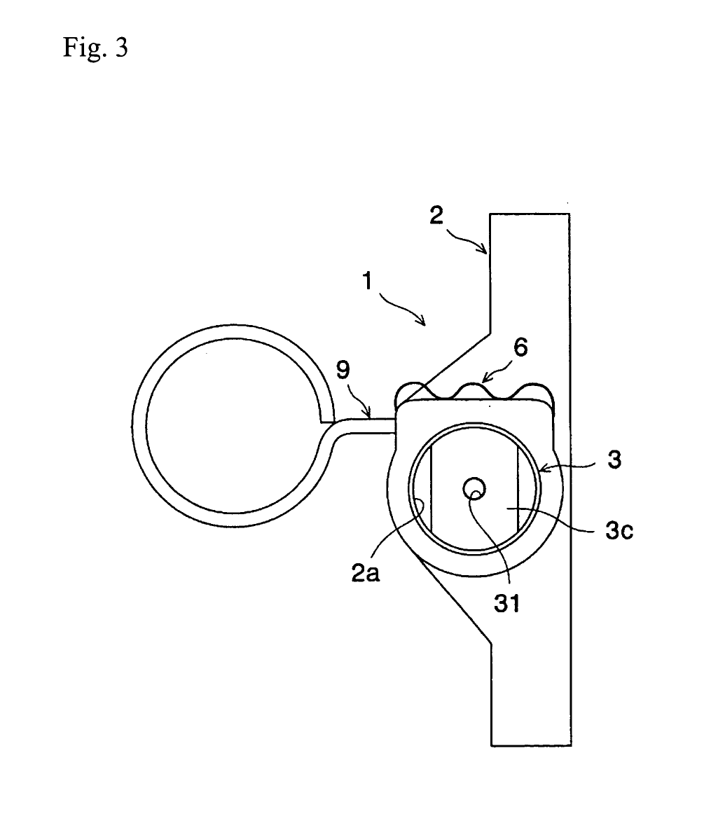

Additionally, in the vicinity of the opening portion of the piston bore 2a of the housing 2, an axial through hole 23 is formed, as shown in FIGS. 1 and 6. On the top portion of the piston 3, an engaging groove 3e extending in the width direction is preferably formed, shown in FIG. 4. The through hole 23 and engaging groove 3e are aligned when the piston 2 is retracted. In transportation of a tensioner, the retracted state of the piston 2 is maintained by inserting a retaining pin 9 shown in FIG. 3 into the through hole 23 and engaging groove 3e.

As shown in FIG. 4, a stop groove 3d is preferably formed at the back of the rearmost tooth of the rack teeth 3b of the piston 3 so that the tooth portion 5a of the pawl member 5 can engage the stop groove 3d to prevent further protrusion of the piston 3 when the piston 3 moves in the protruding direction.

In operation, when the chain slacks or the tension in the chain decreases, the force of the piston spring 4 causes the piston 3 to protrude from the housing 2. If the front end surface 5c (FIG. 4) of the pawl member 5 is clear of the inside wall surface of the opening 2b of housing 2, the pawl member 5 travels along with the piston 3 with the rack teeth 3b engaged with the teeth portion 5a of the pawl member 5. Further, in the event that the piston 3 travels further after the front end surface 5c of the pawl member 5 contacts the inside wall surface of the opening 2b of the housing 2, the rack teeth 3b of the piston 3 pass some of the teeth of the teeth portion 5b of the pawl member 5.

Protruding movement of the piston 3 creates a vacuum condition in the fluid chamber 30, thereby causing the check valve 7 to open to introduce engine oil into the fluid chamber 30 through the check valve 7 from the inlet passage 10. As a result, combined efforts of the force of the piston spring 4 and the hydraulic pressure of the fluid chamber 30 act upon the chain via the tensioner arm to maintain the tension in the chain.

When the chain presses against the tip end 3c of the piston 3 and there is not adequate hydraulic pressure in the fluid chamber 30 (such as when the engine is starting), the piston 3 retracts along with the pawl member 5 with the engagement of the rack teeth 3b of the piston 3 with the teeth portion 5a of the pawl member 5 being maintained. Then, the rear end surface 5d (FIG. 4) of the pawl member 5 presses against the inside wall surface of the opening 2b of the housing 2, thereby causing the retracting movement of the piston 3 to stop.

At this time, a contact area of the rear end surface 5d of the pawl member 5 on the inside wall surface 25 (FIG. 6) of the opening 2b of the housing 2 is, as shown in FIG. 7, a hatched region “a.” In contrast, a contact area of the pawl member of the prior art is shown as a hatched region “b” in FIG. 7. Thus, as FIG. 7 makes clear, this invention makes the contact/pressure area “a” on the inside wall surface 25 of the opening 2b of the housing 2 much larger than the contact/pressure area “b” of the prior art tensioner, thereby preventing excessive pressure from acting upon the housing 2 via the pawl member 5 at the time of retraction of the piston 3.

As a result, even in the case where the housing 2 is formed of a relatively softer material such as aluminum and the hardness of the pawl member 5 is higher than that of the housing 2, increase in the contact area of the pawl member 5 on the housing 2 decreases the surface pressure on the pressure surface of the housing 2, thereby preventing deformation of the surface of the housing 2.

Moreover, since each of the U-shaped portions 6a, 6b of the pawl spring 6 is disposed symmetrically about the axial centerline of the piston 3, a pawl member 5 of a greater width will not incline on either side and the engaging state of the teeth portion 5a of the pawl member 5 with the rack teeth 3a of the piston 3 can be stably maintained.

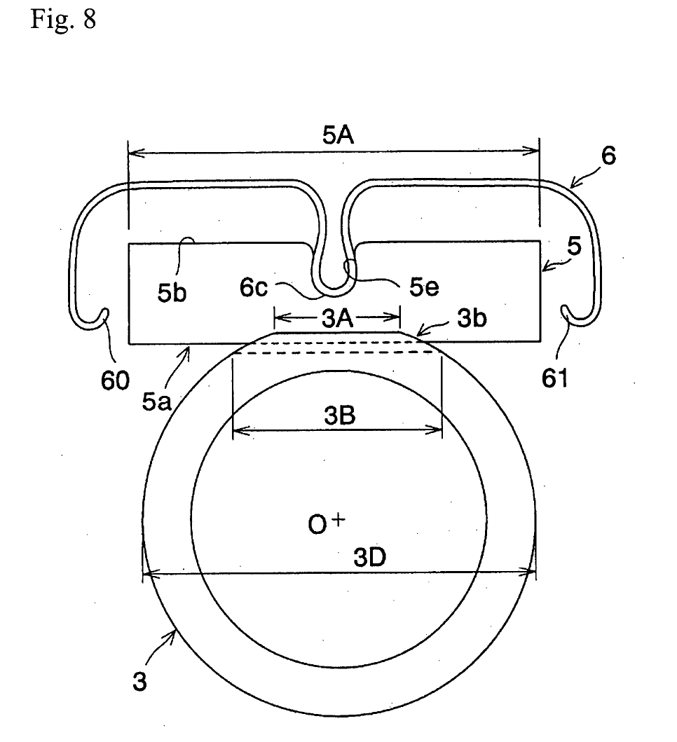

FIG. 8 shows a variation of the first embodiment of the pawl member and the pawl spring. In the figure, the like reference numbers indicate identical or functionally similar elements. As shown in this figure, the pawl member 5 has an axially extending groove 5e on the backside surface thereof. The pawl spring 6 is formed with a U-shaped portion 6c on its center portion, which engages the groove 5e of the pawl member 5.

In this embodiment, since the pawl member 5 is guided by the U-shaped portion 6c of the pawl spring 6 when the pawl member 5 travels along with the piston 3, the axial movement of the pawl member 5 can be more stably maintained. Furthermore, by providing a groove on the backside of the pawl member 5, the center of the moment of inertia of the pawl member 5 is transferred downwardly to the side of the teeth portion 5a of the pawl member 5. Therefore, when a rotational moment from the piston 3 acts on the pawl member 5, the pawl member 5 is prevented from lifting off from the opening 2b.

In the above-mentioned embodiments, the width 5A of the pawl member 5 is made greater than that of the outer diameter 3D of the piston 3, but the present invention is not limited to this example. At a minimum, the width 5A of the pawl member 5 is greater than that of at least the tip portion of the rack teeth 3b of the piston 3. In this embodiment, the pressure surface area of the pawl hole of the housing is still enlarged compared to the pawl member of prior art.

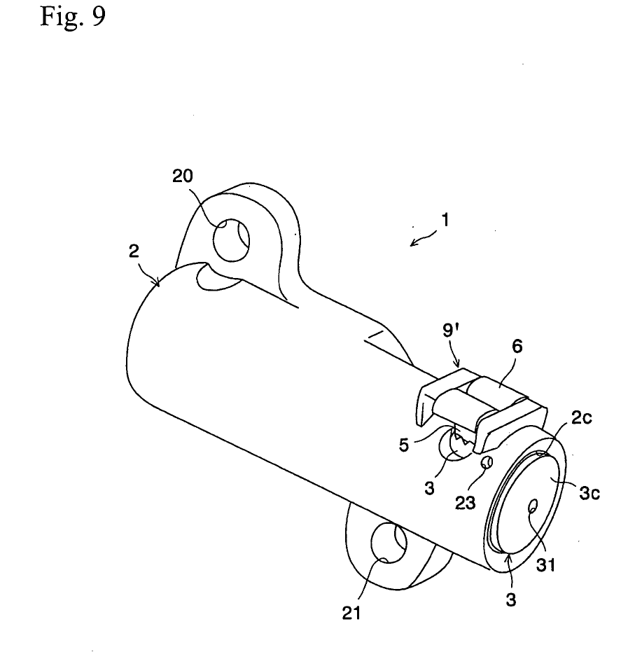

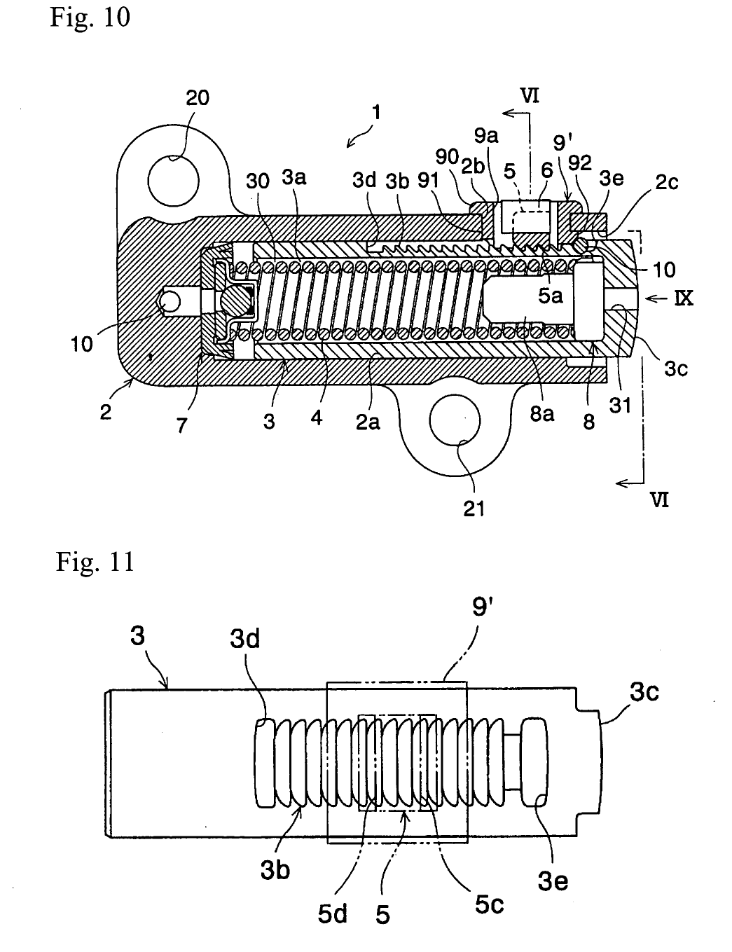

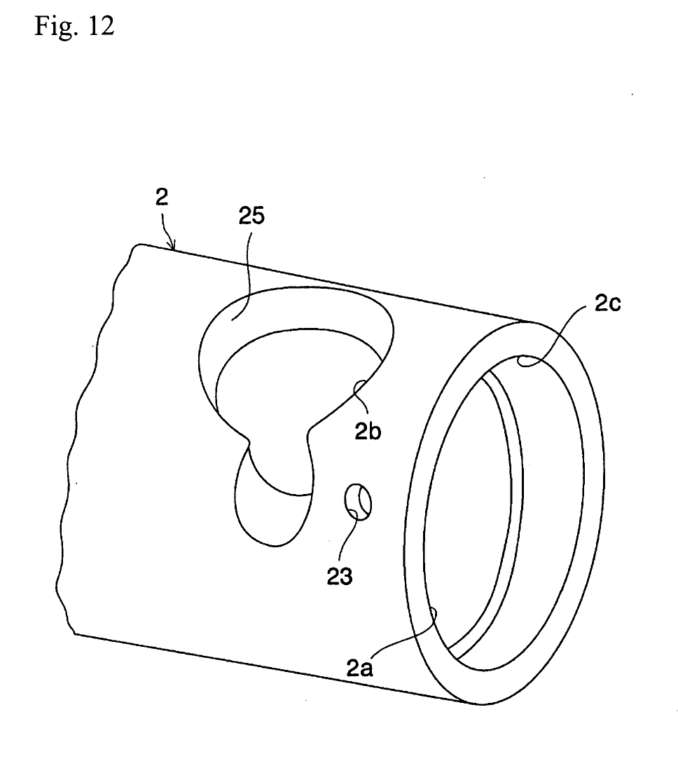

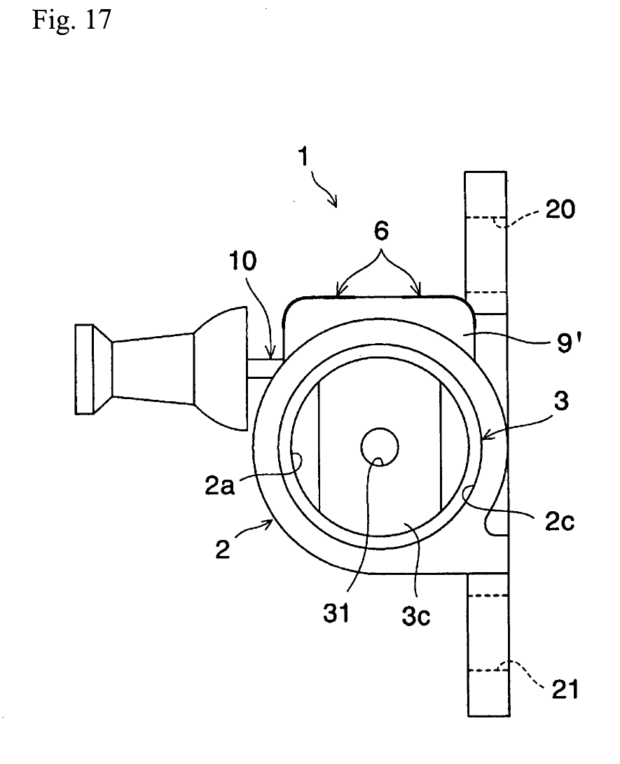

Another preferred embodiment of the present invention is illustrated in FIGS. 9 through 19 (where like numbers indicate structures like those previously described in FIGS. 1 through 8). As will be noted upon reviewing these figures, particularly FIGS. 9 through 12, this embodiment is similar in most respects to the embodiment described with respect to FIGS. 1 through 8. Rack teeth 3b are formed on a portion of an outer circumference of the piston 3 (see FIG. 11). However, in this embodiment, a retainer hole forms retraction blocking member opening (“opening 2b”) rather than a pawl hole. Opening 2b is formed in the housing 2 and opens radially into the piston bore 2a (see FIG. 12). Pawl member 5 is disposed on the rack teeth 3b of the piston 3 inside the opening 2b, with the pawl member 5 having a teeth portion 5a engageable with the rack teeth 3b of the piston 3 on the bottom surface thereof.

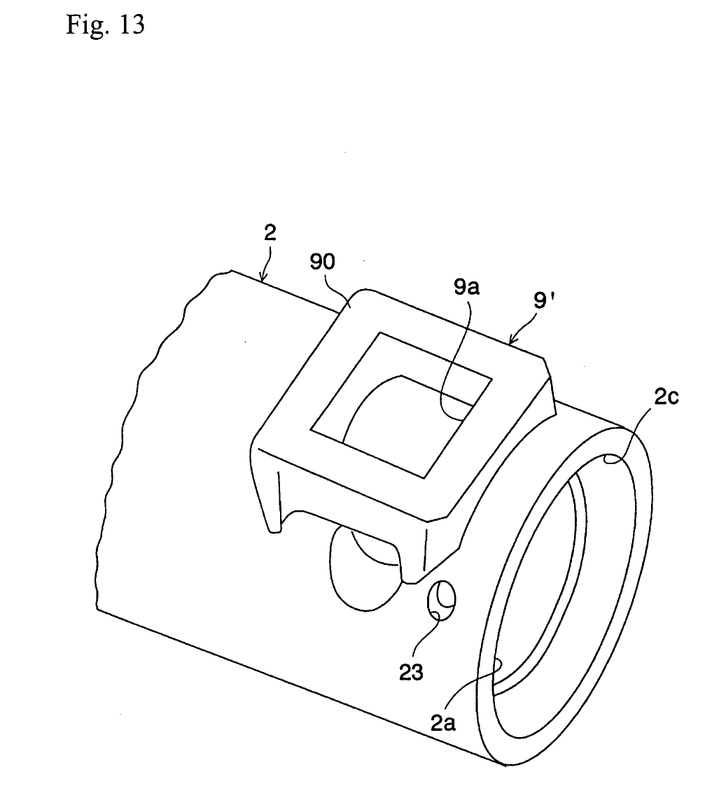

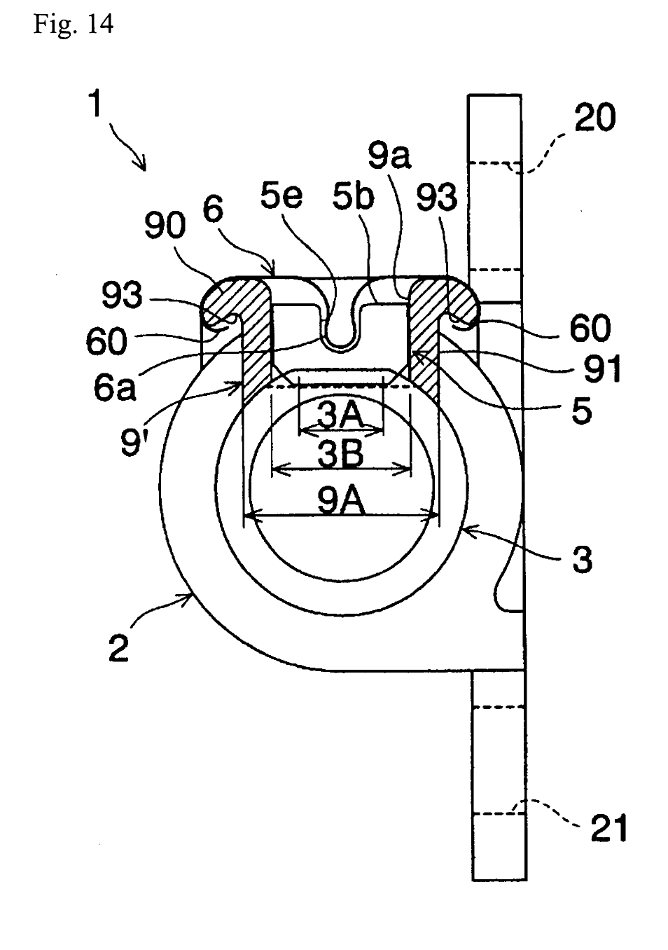

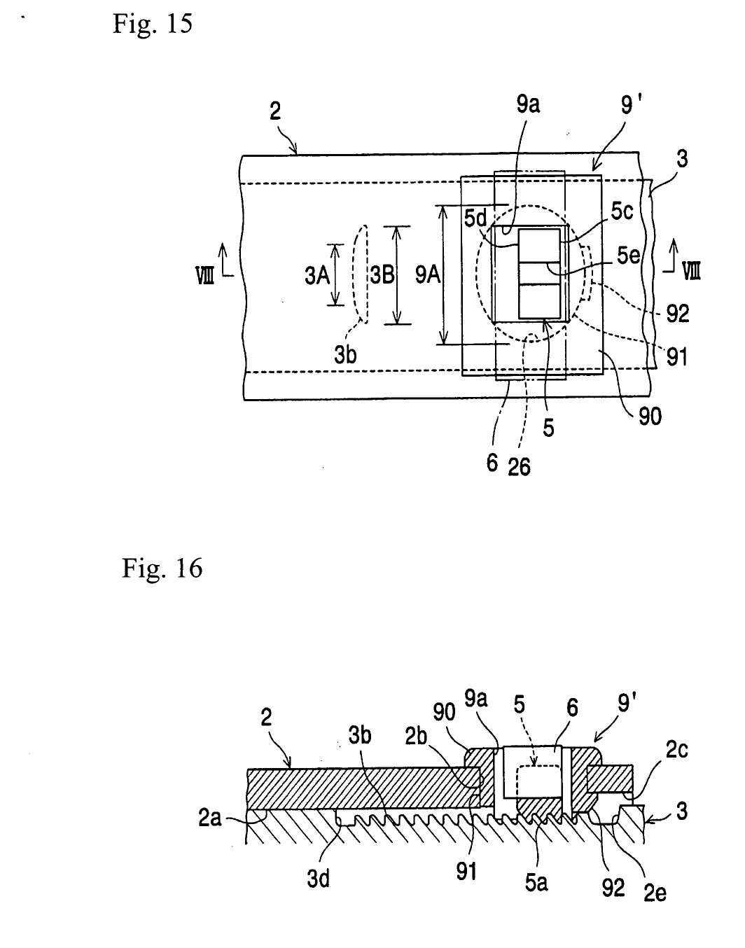

A pawl retainer 9′ is mounted on the opening 2b of the housing 2 (see FIG. 13). The pawl retainer 9′ has a pawl housing through hole 9a with a square-shaped cross section to receive the pawl member 5. The pawl retainer 9′ preferably has a square-shaped flange portion 90 at its upper portion and an axial portion 91 (see FIG. 14) at its lower portion that is integrally formed with the flange portion 90 and that is disposed in the opening 2b of the housing 2. The axial portion 91 has, as shown in FIGS. 15 and 16, an outer cylindrical circumference and is surrounded by the inside wall surface of the opening 2b.

A protrusion 92 that protrudes radially is formed on a portion of the axial portion 91 of the pawl retainer 9′. And, a counterbore 2c, which is greater than the piston bore 2a, is preferably formed at the opening end of the piston bore 2a of the housing 2. The pawl retainer 9′ is detachably fitted in the counterbore 2b by snapping-in the protrusion 92 into the counterbore 2c. Also, a lower end of the protrusion 92 of the pawl retainer 9′ is located in the vicinity of the rack teeth 3b of the piston 3, thereby preventing the rotation the piston 3.

As shown in FIG. 15, the maximum width 9A, which is the maximum length of the axial portion 91 of the pawl retainer 9′ in the width direction, is the width of the attachment surface of the pawl retainer 9′ relative to the opening 2b. This width is greater than the width 3A of the tip portion of the rack teeth 3b of the piston 3. Preferably, it is also greater than the width 3B of the bottom portion of the rack teeth 3b of the piston 3 (see FIG. 14).

As shown most clearly in FIGS. 9, 10 and 14-17, a pawl spring 6 is provided in the pawl retainer 9′ that biases the pawl member 5 against the rack teeth 3b of the piston 3 to engage the teeth portion 5a of the pawl member 5 with the rack teeth 3b of the piston 3. The pawl spring 6 preferably has a pair of engaging hooks 60 at its opposite ends (see FIG. 14). The pawl retainer 9′ preferably has a pair of engaging recesses 93 for receiving the engaging hooks 60 of the pawl spring 6.

The pawl spring 6 preferably has at least one U-shaped bent portion 6a (see FIG. 14) that has been formed by bending a band-shaped sheet metal. The pawl member 5 preferably has an axially extending groove 5e formed on the back surface 5b thereof for receiving the U-shaped bent portion 6a of the pawl spring 6 of this embodiment.

In operation, when the chain slacks or the tension in the chain decreases, the force of the piston spring 4 causes the piston 3 to protrude from the housing 2. If a clearance is formed between the front end surface 5c (FIG. 15) of the pawl member 5 and the pawl housing hole 9a of the pawl retainer 9′, the piston 3 travels along with the pawl member 5 with the rack teeth 3b engaged with the teeth portion 5a of the pawl member 5. In the event that the piston 3 further travels with the front end surface 5c of the pawl member 5 contacted with the pawl housing hole 9a of the pawl retainer 9′, the rack teeth 3b of the piston 3 pass some of the teeth of the teeth portion 5b of the pawl member 5.

When the chain presses against the tip end 3c of the piston 3 in the case and inadequate hydraulic pressure exists in the fluid chamber 30 (such as when the engine starts), the piston 3 retracts along with the pawl member 5 with the engagement of the rack teeth 3b of the piston 3 with the teeth portion 5a of the pawl member 5 maintained. The rear end surface 5d (FIG. 15) of the pawl member 5 presses against the pawl housing hole 9a of the pawl retainer 9′, thereby causing the retracting movement of the piston 3 to stop.

The pawl member 5 exerts pressure on the inside wall surface 25 of the opening 2b of the housing 2 via the axial portion 91 of the pawl retainer 9′. Since the maximum width 9A of the axial portion 91 of the pawl retainer 9′ is greater than the width 3A of the tip portion of the rack teeth 3b of the piston 3, the contact area of the axial portion 91 of the pawl retainer 9′ relative to the inside wall surface 25 of the opening 2b of the housing 2 is large. Thus, the pressure surface area on the inside wall surface 25 of the opening 2b of the housing 2 is large, thereby preventing excessive pressure of the pawl member 5 from acting upon the housing 2 at the time of retraction of the piston 3, and thus, preventing the deformation of the housing 2.

Also, since the maximum width 9A of the axial portion 91 of the pawl retainer 9′ is preferably greater than the width 3B of the bottom portion of the rack teeth 3b of the piston 3, the pressure surface area on the inside wall surface 25 of the opening 2b of the housing 2 is even further enlarged, thereby effectively preventing excessive pressure of the pawl member 5 from acting upon the housing 2 at the time of retraction of the piston 3.

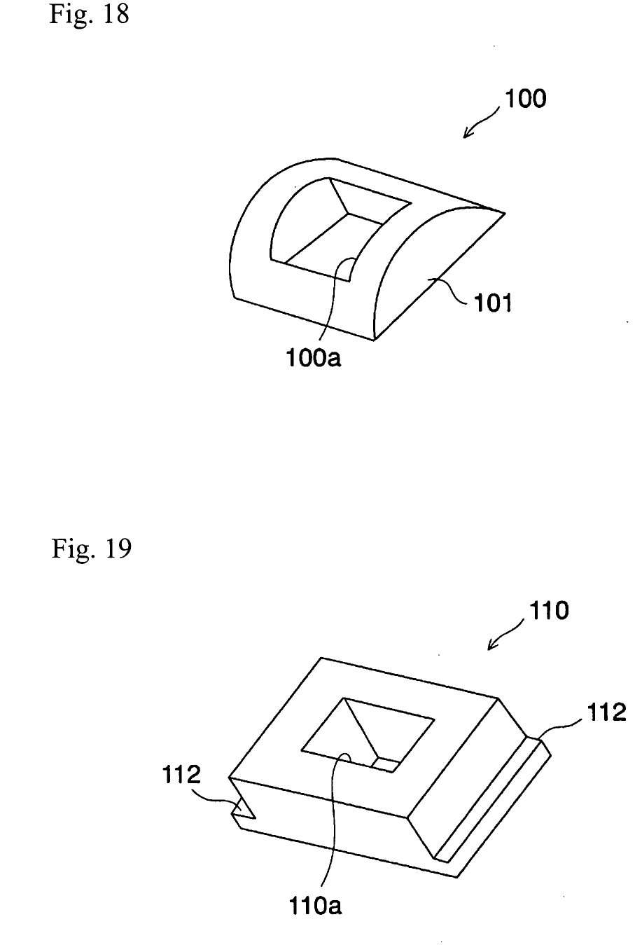

The pawl retainer of the present invention is not limited to one having the axial portion shown in the above-described embodiments. A pawl retainer 100 with a round surface shown in FIG. 18 may also be employed. In this variation, the opposite end surfaces 101 of the pawl retainer 100 are press fit into the opening 2b of the housing 2. A reference numeral 100a indicates a pawl housing hole formed in the pawl retainer 100.

FIG. 19 shows a pawl retainer 110 according to still another variation of this embodiment of the present invention. There are flanges 112 on opposite ends of the pawl retainer 110. The pawl retainer 110 is releaseably fitted into the opening 2b by engaging the flanges 112 with grooves (not shown) formed in the opening 2b of the housing 2. A reference numeral 110a is a pawl housing hole formed in the pawl retainer 110.

Those skilled in the art to which the invention pertains may make modifications and other embodiments employing the principles of this invention without departing from its spirit or essential characteristics particularly upon considering the foregoing teachings. The described embodiments and examples are to be considered in all respects only as illustrative and not restrictive. The scope of the invention is, therefore, indicated by the appended claims rather than by the foregoing description. Consequently, while the invention has been described with reference to particular embodiments and examples, modifications of structure, sequence, materials and the like would be apparent to those skilled in the art, yet fall within the scope of the invention. Accordingly, reference herein to details of the illustrated embodiments is not intended to limit the scope of the claims, which themselves recite those features regarded as essential to the invention.

What is claimed is:

1. A hydraulic tensioner for imparting tension to a chain comprising:
a housing having a retraction blocking member opening extending into a piston hole in an interior of the housing;
a hollow piston that is axially slidable in the piston hole, the piston having an inside space that forms a fluid chamber with the piston hole, the piston comprising a plurality of rack teeth on at least a portion of an outer circumference of the piston;
a piston spring provided in the piston hole, wherein the piston spring urges the piston in an extending direction;
a retraction blocking member located in the retraction blocking member opening and disposed adjacent to the rack teeth of the piston, the retraction blocking member comprising a teeth portion engageable with the rack teeth of the piston and adapted to permit movement of the piston in the extending direction but to prevent movement in a retracting direction; and
a retraction blocking member spring urging the teeth portion to engage with the rack teeth;
wherein the retraction blocking member has a width greater than that of a tip portion of the rack teeth of the piston.

2. The hydraulic tensioner of claim 1:
wherein the retraction blocking member opening comprises a pawl hole;
wherein the retraction blocking member comprises a pawl member provided in the pawl hole, wherein there is an axial clearance between the pawl hole and the pawl member;
wherein the retraction blocking member spring comprises a pawl spring; and
wherein the width of the retraction blocking member comprises a width of the pawl member.

3. The hydraulic tensioner of claim 1, wherein the retraction blocking member has a width greater than that of a bottom portion of the rack teeth of the piston.

4. The hydraulic tensioner of claim 1, wherein the retraction blocking member has a width greater than that of an outer diameter of the piston.

5. The hydraulic tensioner of claim 1, wherein the retraction blocking member spring comprises at least one U-shaped bent portion symmetrically disposed about an axial centerline of the piston, the bent portion contacting a back surface of the retraction blocking member.

6. The hydraulic tensioner of claim 5, wherein the U-shaped bent portion is formed by bending a band-shaped sheet of metal.

7. The hydraulic tensioner of claim 1, wherein the retraction blocking member spring comprises two U-shaped bent portions which form a W-shaped bent portion, wherein each U-shaped portion is symmetrically disposed about an axial centerline of the piston, the bent portion contacting a back surface of the retraction blocking member.

8. The hydraulic tensioner of claim 1, wherein the retraction blocking member spring comprises at least one U-shaped bent portion and the retraction blocking member comprises at least one axially extending groove on a back surface thereof, such that the U-shaped bent portion of the retraction blocking member spring engages the groove.

9. The hydraulic tensioner of claim 8, wherein the U-shaped bent portion is formed by bending a band-shaped sheet of metal.

10. The hydraulic tensioner of claim 1, wherein the hydraulic tensioner further comprises a pair of engagement recesses and the retraction blocking member spring comprises a pair of engaging hooks on opposite ends thereof such that the engaging hooks of the retraction blocking member spring engage the engagement recesses.

11. The hydraulic tensioner of claim 1, wherein the housing comprises a check valve at a bottom portion of the piston hole, wherein the check valve permits fluid flow into the fluid chamber but blocks reverse flow out of the fluid chamber.

12. The hydraulic tensioner of claim 1, wherein the housing comprises a material having a hardness lower than a hardness of a material that comprises the retraction blocking member.

13. The hydraulic tensioner of claim 1, wherein the housing is composed of aluminum.

14. The hydraulic tensioner of claim 1, wherein the retraction blocking member comprises a front end surface and a rear end surface, and the retraction blocking member opening comprises a retraction blocking member opening surface such that the front end surface or the rear end surface of the retraction blocking member contacts the retraction blocking member opening surface when the retraction blocking member extends or retracts.

15. The hydraulic tensioner of claim 1, wherein the retraction blocking member opening comprises a retainer hole radially penetrating into the piston hole, and the retraction blocking member comprises:
a pawl member located in the retainer hole and disposed adjacent to the rack teeth of the piston, wherein the pawl member comprises the teeth portion engageable with the rack teeth of the piston; and
a pawl retainer mounted on the retainer hole and having a pawl housing hole for housing the pawl member;
wherein the retraction blocking member spring comprises a pawl spring; and
wherein a width of an attachment surface of the pawl retainer relative to the retainer hole is the retraction blocking member width.

16. The hydraulic tensioner of claim 15, wherein the housing further comprises a counterbore at an opening end of the piston hole, the counterbore having a greater diameter than a diameter of the piston hole, and wherein the pawl retainer comprises a lower elongated end disposed in a vicinity of the rack teeth of the piston, such that the lower elongated end of the pawl retainer prevents the piston from rotating.
